(19) United States
(12) Patent Application Publication
(10) Pub. No.: US 2019/0026222 A1
(43) Pub. Date: Jan. 24, 2019

(54) CONTROLLER AND OPERATION METHOD THEREOF

(71) Applicant: SK hynix Inc., Gyeonggi-do (KR)

(72) Inventors: Duck-Hoi KOO, Gyeonggi-do (KR); Yong-Tae KIM, Gyeonggi-do (KR); Soong-Sun SHIN, Gyeonggi-do (KR); Cheon-Ok JEONG, Gyeonggi-do (KR)

(21) Appl. No.: 15/902,485

(22) Filed: Feb. 22, 2018

(30) Foreign Application Priority Data
Jul. 19, 2017 (KR) 10-2017-0091536

(51) Int. Cl. G06F 12/02; G06F 3/06; G06F 12/123; G06F 12/0893; G06F 12/0868

(52) U.S. Cl. CPC G06F 12/0246; G06F 3/0679; G06F 3/0608; G06F 12/123; G06F 2212/1032; G06F 3/064; G06F 12/0893; G06F 12/0868; G06F 3/0652

(57) ABSTRACT

A controller includes: a victim list update unit suitable for storing information on an error block in a victim list when the error block is detected; a control unit suitable for deciding whether or not to perform a copy operation based on whether or not a predetermined condition is satisfied; a copy unit suitable for copying the error block into a destination super block while maintaining a location of a die when the control unit performs the copy operation; and a victim list delete unit suitable for deleting the victim list including the error block when the copy operation ends.

### CROSS-REFERENCE TO RELATED APPLICATIONS

The present application claims priority of Korean Patent Application No. 10-2017-0091536, filed on Jul. 19, 2017, which is incorporated herein by reference in its entirety.

### BACKGROUND

### 1. Field

Exemplary embodiments of the present invention relate to a controller, and more particularly, to a controller capable of supporting error management and a method for operating the controller.

### 2. Description of the Related Art

The paradigm for computing environments is shifting toward ubiquitous computing which allows users to use computer systems anytime, anywhere. For this reason, the demands for portable electronic devices, such as mobile phones, digital cameras and laptop computers are soaring. Those electronic devices generally include a memory system using a memory device as a data storage device. The data storage device may be used as a main memory unit or an auxiliary memory unit of a portable electronic device.

Since the data storage device using a memory device is not provided with a mechanical driving unit, it may have excellent stability and durability. Also, the data storage device has a quick data access rate with low power consumption. Non-limiting examples of the data storage device having such advantages include Universal Serial Bus (USB) memory devices, memory cards of diverse interfaces, Solid-State Drives (SSD) and the like.

### SUMMARY

Embodiments of the present invention are directed to a memory system capable of supporting a sequential read operation by moving data of an error block within a die including the error block, and a method for operating the memory system.

In accordance with an embodiment of the present invention, a controller includes: a victim list update unit suitable for storing information on an error block in a victim list when the error block is detected; a control unit suitable for deciding whether or not to perform a copy operation based on whether or not a predetermined condition is satisfied; a copy unit suitable for copying the error block into a destination super block while maintaining a location of a die when the control unit performs the copy operation; and a victim list delete unit suitable for deleting the victim list including the error block when the copy operation ends.

The predetermined condition may be a condition where a state of an oldest victim list is full.

The error block is a block that is to have a read error or a block where a write error is detected.

The predetermined condition may be one between a condition that a read count of the error block exceeds a predetermined second threshold value and a condition that a state of a super block including the error block is closed.

The victim list update unit may store the information on the error block in the victim list for each die.

The information on the error block may be a physical block address of the detected error block.

The victim list may be stored in a volatile memory.

The block that is likely to have a read error is a block where a read count of the block exceeds a predetermined first threshold value.

When the predetermined condition is satisfied, the copy unit may copy the error block that belongs to a victim list satisfying the predetermined condition into the destination super block while maintaining the location of the die.

When the predetermined condition is satisfied, the copy unit may copy the error block that belongs to a victim list including the error block satisfying the predetermined condition into the destination super block while maintaining the location of the die, and copy a victim block selected from a user area into the destination super block.

A block including invalid pages most may be selected as the victim block.

In accordance with another embodiment of the present invention, a method for operating a controller includes: when an error block is detected, storing information on the error block in a victim list; deciding whether to perform a copy operation or not based on whether a predetermined condition is satisfied or not; when the copy operation is decided to be performed, copying the error block, which is a target for the copy operation, into a destination super block while maintaining a location of a die; and when the copy operation ends, deleting the victim list including the error block, which is the target for the copy operation.

The predetermined condition may be a condition where a state of an oldest victim list is full.

The error block is a block that is likely to have a read error or a block where a write error is detected and the predetermined condition may be one between a condition that a read count of the error block exceeds a predetermined second threshold value and a condition that a state of a super block including the error block is closed.

In the storing of the information on the error block in the victim list, the information on the error block may be stored in the victim list for each die.

The information on the error block may be a physical block address of the detected error block.

The victim list may be stored in a volatile memory.

The block that is likely to have the read error may be a block where a read count of the block exceeds a predetermined first threshold value.

When the predetermined condition is satisfied, the error block that belongs to a victim list satisfying the predetermined condition may be copied into the destination super block while maintaining the location of the die in the copying of the error block, which is the target for the copy operation, into the destination super block while maintaining the location of the die.

When the predetermined condition is satisfied, the error block that belongs to a victim list including the error block satisfying the predetermined condition may be copied into the destination super block while maintaining the location of the die, and a victim block selected from a user area may be copied into the destination super block in the copying of the error block, which is the target for the copy operation, into the destination super block while maintaining the location of the die.

A block including invalid pages most may be selected as the victim block.

In accordance with another embodiment of the present invention, a memory system includes: a memory device including super memory blocks each having a predetermined number of blocks from different dies; a controller suitable for: detecting as an error block a block having a write error and a block likely to have a read error among the blocks; generating one or more victim lists each having the predetermined number of die fields corresponding to the dies, wherein each die field has a single entry adapted to identify the error block of a corresponding die; and controlling, when an oldest one among the victim lists becomes full of entries, the memory device to copy data of the error blocks identified by the entries and the data fields into blocks of the same dies as the error blocks, respectively, in a free super memory block.

These and other features and advantages of the present invention will become apparent to those with ordinary skill in the art to which the present invention belongs from the following detailed description in conjunction with the accompanying drawings.

### BRIEF DESCRIPTION OF THE DRAWINGS

FIG. 1 is a block diagram illustrating a data processing system including a memory system, in accordance with an embodiment of the present invention.

FIG. 2 is a schematic diagram illustrating an exemplary configuration of a memory device employed in the memory system shown in FIG. 1.

FIG. 3 is a circuit diagram illustrating an exemplary configuration of a memory cell array of a memory block in the memory device shown in FIG. 2.

FIG. 4 is a schematic diagram illustrating an exemplary three-dimensional structure of the memory device shown in FIG. 2.

FIG. 5 illustrates an error management operation in accordance with an embodiment of the present invention.

FIG. 6 illustrates an operation of a mode 2 copy unit shown in FIG. 5.

FIG. 7 is a flowchart describing an error management operation in accordance with an embodiment of the present invention.

FIGS. 8 to 16 are diagrams schematically illustrating application examples of the data processing system shown in FIG. 1, in accordance with various embodiments of the present invention.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The drawings are not necessarily to scale and in some instances, proportions may have been exaggerated in order to clearly illustrate features of the embodiments.

It is noted that well-known structures and processes are omitted herein in order to avoid obfuscating the disclosure of the present invention.

Also, it should be understood that a feature disclosed with one embodiment may also be employed with another embodiment provided that the claimed combination falls within the scope of the present invention as defined by the accompanying claims.

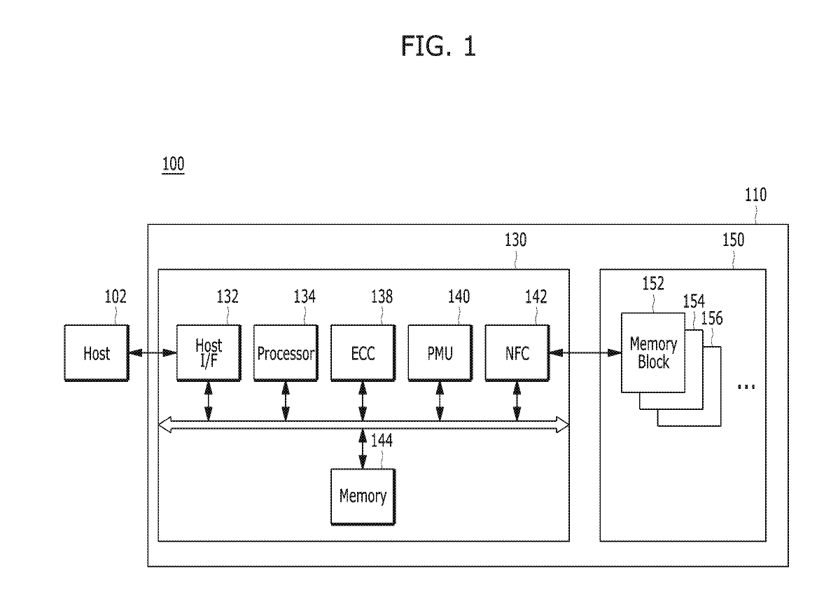

FIG. 1 is a block diagram illustrating a data processing system 100 including a memory system 110 in accordance with an embodiment of the present invention.

Referring to FIG. 1, the data processing system 100 may include a host 102 that is operatively coupled to the memory system 110.

The host 102 may be any suitable electronic device including a portable electronic device such as a mobile phone, an MP3 player and a laptop computer or a non-portable electronic device such as a desktop computer, a game machine, a TV and a projector.

The host 102 may include at least one OS (operating system), and the OS may manage and control the overall functions and operations of the host 102, and provide an operation between the host 102 and a user using the data processing system 100 or the memory system 110. The OS may support functions and operations corresponding to the use purpose and usage of a user. For example, the OS may be divided into a general OS and a mobile OS, depending on the mobility of the host 102. The general OS may be divided into a personal OS and an enterprise OS, depending on the environment of a user. For example, the personal OS configured to support a function of providing a service to general users may include Windows and Chrome, and the enterprise OS configured to secure and support high performance may include Windows server, Linux and Unix. Furthermore, the mobile OS configured to support a function of providing a mobile service to users and a power saving function of a system may include Android, iOS and Windows Mobile. At this time, the host 102 may include a plurality of OSs, and execute an OS to perform an operation corresponding to a user's request on the memory system 110.

The memory system 110 may operate to store data for the host 102 in response to a request received from the host 102. Non-limited examples of the memory system 110 may include a solid-state drive (SSD), a multi-media card (MMC), a secure digital (SD) card, a universal storage bus (USB) device, a universal flash storage (UFS) device, compact flash (CF) card, a smart media card (SMC), a personal computer memory card international association (PCMCIA) card and a memory stick. The MMC may include an embedded MMC (eMMC), a reduced size MMC (RS-MMC) and a micro-MMC. The SD card may include a mini-SD card and a micro-SD card.

The memory system 110 may employ various types of storage devices. Non-limited examples of storage devices included in the memory system 110 may include volatile memory devices such as a dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM) and a flash memory. The memory device may have a 3-dimensional (3D) stack structure. For example, the memory device may be a flash memory having a 3D stack structure.

The memory system 110 may include a memory device 150 and a controller 130 operatively coupled to each other. The memory device 150 may store data for the host 120, and the controller 130 may control storing data into the memory device 150, reading data from the memory device 150, and transferring the read data to the host HOST.

The controller 130 and the memory device 150 may be integrated into a single semiconductor device, which may be included in the various types of memory systems as exemplified above.

Non-limited application examples of the memory system 110 may include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

The memory device 150 may be a nonvolatile memory device and may retain data stored therein even though power is not supplied. The memory device 150 may store data provided from the host 102 through a write operation, and provide data stored therein to the host 102 through a read operation. The memory device 150 may include a plurality of memory dies (not shown), each memory die including a plurality of planes (not shown), and each plane including a plurality of memory blocks 152 to 156. Each of the memory blocks 152 to 156 may include a plurality of pages, and each of the pages may include a plurality of memory cells coupled to a word line. In an embodiment, the memory device 150 may be a flash memory. The flash memory may have a 3D stack structure.

The controller 130 may control the memory device 150 in response to a request from the host 102. For example, the controller 130 may provide data read from the memory device 150 to the host 102, and store data provided from the host 102 into the memory device 150. For this operation, the controller 130 may control read, write, program and erase operations of the memory device 150.

The controller 130 may include a host interface (I/F) unit 132, a processor 134, an error correction code (ECC) unit 138, a Power Management Unit (PMU) 140, a memory device controller such as a NAND flash controller (NFC) 142 and a memory 144, all operatively coupled via an internal bus.

The host interface unit 132 may be configured to process a command and data of the host 102, and may communicate with the host 102 through one or more of various interface protocols such as universal serial bus (USB), multi-media card (MMC), peripheral component interconnect-express (PCI-E), small computer system interface (SCSI), serial-attached SCSI (SAS), serial advanced technology attachment (SATA), parallel advanced technology attachment (PATH), enhanced small disk interface (ESDI) and integrated drive electronics (IDE).

The ECC unit 138 may detect and correct an error contained in the data read from the memory device 150. In other words, the ECC unit 138 may perform an error correction decoding process to the data read from the memory device 150 through an ECC code used during an ECC encoding process. According to a result of the error correction decoding process, the ECC unit 138 may output a signal, for example, an error correction success/fail signal. When the number of error bits is more than a threshold value of correctable error bits, the ECC unit 138 may not correct the error bits, and may output an error correction fail signal.

The ECC unit 138 may perform error correction through any suitable method including a coded modulation such as Low-Density Parity Check (LDPC) code, Bose-Chaudhuri-Hocquenghem (BCH) code, turbo code, Reed-Solomon code, convolution code, Recursive Systematic Code (RSC), Trellis-Coded Modulation (TCM) and Block coded modulation (BCM). However, the ECC unit 138 is not limited thereto. The ECC unit 138 may include all circuits, modules, systems or devices needed for error correction.

The PMU 140 may provide and manage the power requirements of the controller 130. Any suitable PMU may be employed.

The NFC 142 is an example of a suitable memory/storage interface for interfacing the controller 130 and the memory device 150 such that the controller 130 controls the memory device 150 in response to a request from the host 102, when the memory device is a NAND flash memory. For example, when the memory device 150 is a flash memory or specifically a NAND flash memory, the NFC 142 may generate a control signal for the memory device 150 and process data to be provided to the memory device 150 under the control of the processor 134. The NFC 142 may work as an interface (e.g., a NAND flash interface) for processing a command and data between the controller 130 and the memory device 150. Specifically, the NFC 142 may support data transfer between the controller 130 and the memory device 150. A suitable memory/storage interface may be selected depending upon the type of the memory device 150.

The memory 144 may serve as a working memory of the memory system 110 and the controller 130, and may store data for driving the memory system 110 and the controller 130. The controller 130 may control the memory device 150 to perform read, write, program and erase operations in response to a request received from the host 102. The controller 130 may provide data read from the memory device 150 to the host 102, may store data provided from the host 102 into the memory device 150. The memory 144 may store the data required for the controller 130 and the memory device 150 to perform these operations.

The memory 144 may be embodied by a volatile memory. For example, the memory 144 may be embodied by static random-access memory (SRAM) or dynamic random-access memory (DRAM). The memory 144 may be disposed within or out of the controller 130. FIG. 1 exemplifies the memory 144 disposed within the controller 130. In an embodiment, the memory 144 may be embodied by an external volatile memory having a memory interface transferring data between the memory 144 and the controller 130.

The processor 134 may control the overall operations of the memory system 110. The processor 134 may drive firmware to control the overall operations of the memory system 110. The firmware may be referred to as flash translation layer (FTL).

The processor 134 of the controller 130 may include a management unit (not illustrated) for performing a bad management operation of the memory device 150. The management unit may perform a bad block management operation for checking a bad block, in which a program fail occurs due to a characteristic of the memory device. The management unit may write the program-failed data of the bad block to a new memory block. In a memory device 150 having a 3D stack structure, the bad block management operation may reduce the use efficiency of the memory device 150 and the reliability of the memory system 110. Thus, the bad block management operation needs to be performed with more reliability.

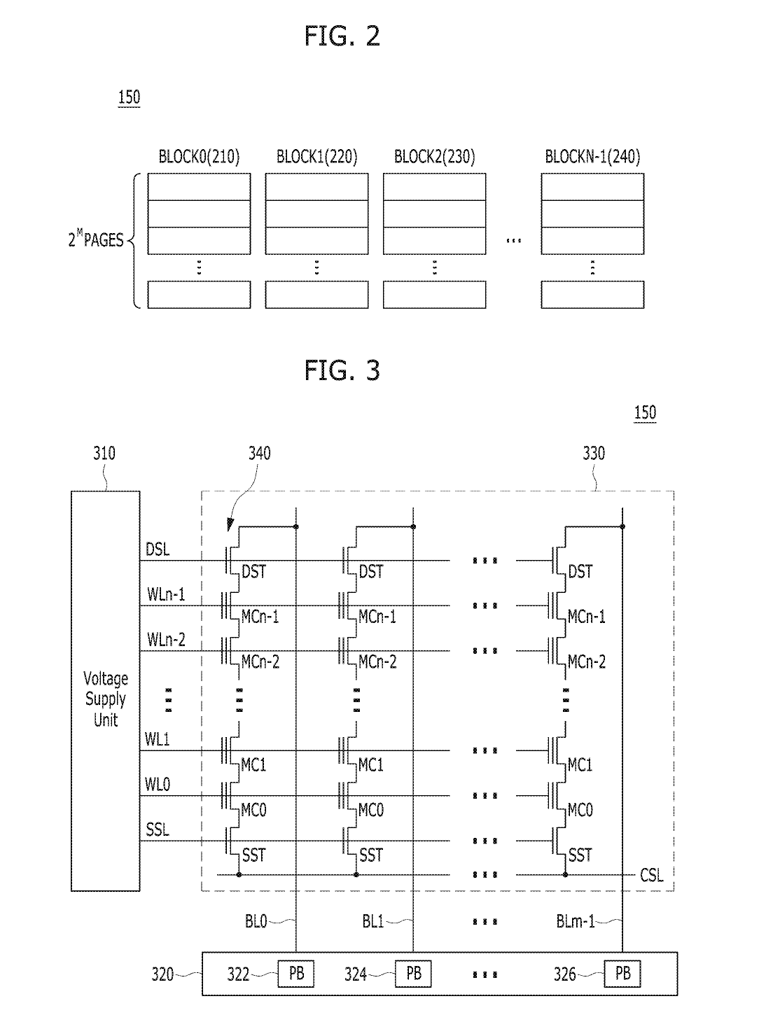

FIG. 2 is a schematic diagram illustrating the memory device 150.

Referring to FIG. 2, the memory device 150 may include a plurality of memory blocks 0 to N−1, and each of the blocks 0 to N−1 may include a plurality of pages, for example, 2M pages, the number of which may vary according to circuit design. Memory cells included in the respective memory blocks 0 to N−1 may be one or more of a single level cell (SLC) storing 1-bit data, a multi-level cell (MLC) storing 2-bit data, a triple level cell (TLC) storing 3-bit data, a quadruple level cell (QLC) storing 4-bit level cell, a multiple level cell storing 5-or-more-bit data, and so forth.

FIG. 3 is a circuit diagram illustrating an exemplary configuration of a memory cell array of a memory block in the memory device 150.

Referring to FIG. 3, a memory block 330 which may correspond to any of the plurality of memory blocks 152 to 156 included in the memory device 150 of the memory system 110 may include a plurality of cell strings 340 coupled to a plurality of corresponding bit lines BL0 to BLm−1. The cell string 340 of each column may include one or more drain select transistors DST and one or more source select transistors SST. Between the drain and select transistors DST and SST, a plurality of memory cells MC0 to MCn−1 may be coupled in series. In an embodiment, each of the memory cell transistors MC0 to MCn−1 may be embodied by an MLC capable of storing data information of a plurality of bits. Each of the cell strings 340 may be electrically coupled to a corresponding bit line among the plurality of bit lines BL0 to BLm−1. For example, as illustrated in FIG. 3, the first cell string is coupled to the first bit line BL0, and the last cell string is coupled to the last bit line BLm−1.

Although FIG. 3 illustrates NAND flash memory cells, the invention is not limited in this way. It is noted that the memory cells may be NOR flash memory cells, or hybrid flash memory cells including two or more types of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply unit 310 which provides word line voltages including a program voltage, a read voltage and a pass voltage to the word lines according to an operation mode. The voltage generation operation of the voltage supply unit 310 may be controlled by a control circuit (not illustrated). Under the control of the control circuit, the voltage supply unit 310 may select one of the memory blocks (or sectors) of the memory cell array, select one of the word lines of the selected memory block, and provide the word line voltages to the selected word line and the unselected word lines as may be needed.

The memory device 150 may include a read/write circuit 320 which is controlled by the control circuit. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs), and each of the page buffers 322 to 326 may include a plurality of latches (not illustrated).

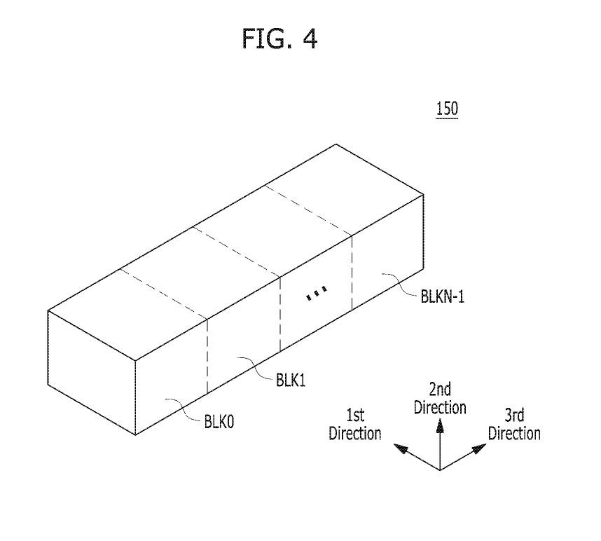

FIG. 4 is a schematic diagram illustrating an exemplary 3D structure of the memory device 150.

The memory device 150 may be embodied by a 2D or 3D memory device. Specifically, as illustrated in FIG. 4, the memory device 150 may be embodied by a nonvolatile memory device having a 3D stack structure. In the illustrated embodiment of FIG. 4, the memory device 150 includes a plurality of memory blocks BLK0 to BLKN−1 each having a 3D structure (or vertical structure).

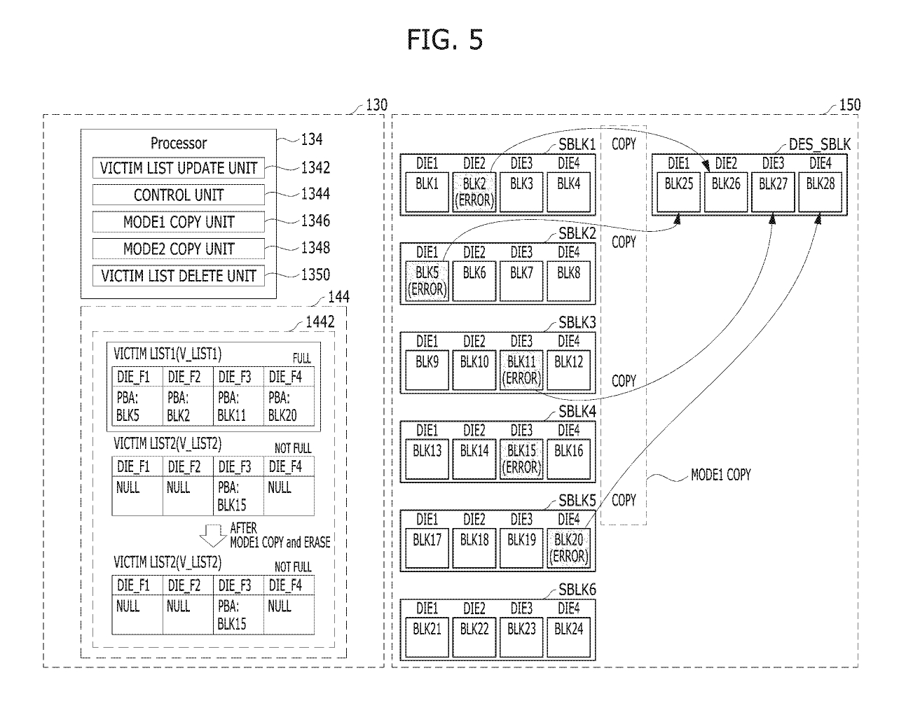

Hereafter, an error management operation according to embodiments of the present invention is described with reference to FIGS. 5 to 7.

FIG. 5 illustrates an error management operation of the memory system 110, in accordance with an embodiment of the present invention.

The error management operation may be performed by the memory device 150 under the control of the controller 130. Through the error management operation, data of a memory block that is likely to have a read error may be copied into another normal memory block. Also, through the error management operation, data of a memory block where a write error is detected may be copied into another normal memory block. Through the error management operation, the occurrence of errors may be prevented and the reliability of data may be secured.

Meanwhile, when the error management operation is performed by units of super blocks, a copy operation is performed onto the data of all memory blocks in the inside of a super block. Therefore, overhead is great. According to the prior art, for reducing the overhead, an error management operation of copying only the data of an error block, i.e., a memory block that is likely to have a read error or a memory block where a write error is detected, may be performed. However, when only the data of the error block, which is part of a super block storing sequential data are copied according to the prior art, the sequentiality of the data stored in the super block may be damaged, which leads to deterioration in read performance consequently.

According to an embodiment of the present invention, it is possible to secure the sequentiality of the data stored in the super block and prevent the read performance from being deteriorated by performing the error management operation in such a manner that a data copy operation is performed within a die including the error block.

According to an embodiment of the present invention, a memory block whose read count exceeds a first threshold value TH1 may be detected as a memory block that is likely to have a read error. The first threshold value TH1 may have a value that is smaller than a read count threshold RTH, which is a reference used to determine whether to perform a read reclaim operation for preventing read disturbance.

According to the embodiment of the present invention, a memory block including a page where an error is detected in the course of writing a data may be determined as a memory block where a write error is detected.

FIG. 5 exemplarily illustrates the memory device 150 including four memory dies DIE<1:4> each of which includes 7 memory blocks.

Furthermore, FIG. 5 exemplarily illustrates the memory device 150 that includes first to sixth super blocks SBLK<1:6> and a destination super block DES_SBLK. Each of the super blocks SBLK<1:6> and DES_SBLK may include four memory blocks respectively included in the four memory dies DIE<1:4>.

For example, the first super block SBLK1 may include a first block BLK1 included in a first die DIE1, a second block BLK2 included in a second die DIE2, a third block BLK3 included in a third die DIE3, and a fourth block BLK4 included in a fourth die DIE4. The second super block SBLK2 may include a fifth block BLK5 included in the first die DIE1, a sixth block BLK6 included in the second die DIE2, a seventh block BLK7 included in the third die DIE3, and an eighth block BLK8 included in the fourth die DIE4. In the same way, the third to sixth super blocks SBLK<3:6> and the destination super block DES_SBLK may be formed.

If any, this is a mere example presented for the sake of convenience in description, and the super blocks may be formed in diverse methods.

A storage unit 1442 of the memory 144 may store a victim list having information on the error block. The information on the error block may include a physical block address (PBA) of the error block.

The processor 134 may include a victim list update unit 1342, a control unit 1344, a mode 1 copy unit 1346, a mode 2 copy unit 1348, and a victim list delete unit 1350. Herein, the mode 1 copy unit 1346 and the mode 2 copy unit 1348 may be collectively referred to as a copy unit.

The victim list update unit 1342 may store the information on the error block in the victim list, when there is an error block.

The victim list may include a plurality of die fields respectively corresponding to a plurality of dies that form a super block. Each of the die fields may have an entry representing one error block that is detected in the corresponding die.

The victim list may be generated by units of super blocks.

When an error block is detected in a die and there is no victim list in the storage unit 1442 of the memory 144, the victim list update unit 1342 may generate a first victim list including plural die fields representing dies of a super blocks including the detected error block and store the physical address of the detected error block as an entry of a die field representing the error-detected die.

Further, when an error block is detected in a die corresponding to a die field already having an entry representing another error block in the currently error-detected die in the first victim list, the victim list update unit 1342 may generate a second victim list for the currently detected error block although the first victim list has one or more die fields having no entry since the victim list may be generated by units of super blocks in accordance with an embodiment of the present invention.

Therefore, there may be several victim lists each having one or more die fields having no entry. In this case, when an error block is detected in a die corresponding to one of the die fields currently having no entry in the victim lists, the victim list update unit 1342 may store the physical address of the currently detected error block as an entry of the die fields currently having no entry and corresponding to the currently error-detected die in the oldest one among the victim lists.

As illustrated in FIG. 5, the victim list may have four die fields DIE_F<1:4> respectively corresponding to the dies DIE<1:4> of each super block, and each of the die fields may have as an entry a value of a physical block address PBA of an error memory block of the corresponding die.

FIG. 5 exemplarily illustrates a case where errors sequentially occur in the second block BLK2 of the second die DIE2, the fifth block BLK5 of the first die DIE1, the 11^{th} block BLK11 and the 15^{th} BLK15 of the third die DIE3, and the 20^{th} block BLK20 of the fourth die DIE4.

First of all, when the second block BLK2 of the second die DIE2 is an error block, the victim list update unit 1342 may generate a first victim list V_LIST1 in the storage unit 1442 of the memory 144. Also, the victim list update unit 1342 may store a physical block address PBA:BLK2 of the second block BLK2 in the second die field DIE_F2 of the first victim list V_LIST1 corresponding to the second die DIE2 to which the second block BLK2 belongs.

Subsequently, when the fifth block BLK5 of the first die DIE1 is an error block, the victim list update unit 1342 may store a physical block address PBA: BLK5 of the fifth block BLK5 in the first die field DIE_F1 of the first victim list V_LIST1 corresponding to the first die DIE1 to which the fifth block BLK5 belongs.

Subsequently, when the 11^{th} block BLK11 of the third die DIE3 is an error block, the victim list update unit 1342 may store a physical block address PBA: BLK11 of the 11^{th} block BLK11 in the third die field DIE_F3 of the first victim list V_LIST1 corresponding to the third die DIE3 to which the 11^{th} block BLK11 belongs.

Subsequently, when the 15^{th} block BLK15 of the third die DIE3 is an error block, the 15^{th} block BLK15 may be included in the third die DIE3. Since the physical block address PBA:BLK11 of the 11^{th} block BLK11 is already stored in the third die field DIE_F3 of the first victim list V_LIST1, the victim list update unit 1342 may not store a physical block address PBA:BLK15 of the 15^{th} block BLK15 in the third die field DIE_F3 of the first victim list V_LIST1. Instead, the victim list update unit 1342 may generate a second victim list V_LIST2 and store the physical block address PBA: BLK15 of the 15^{th} block BLK15 in the third die field DIEF3 of the second victim list VLIST2 corresponding to the third die DIE3 to which the 15^{th} block BLK15 belongs.

Subsequently, when the 20^{th} block BLK20 of the fourth die DIE4 is an error block, the victim list update unit 1342 may store a physical block address PBA: BLK20 of the 20^{th} block BLK20 in a fourth die field DIE_F4 of the first victim list V_LIST1 corresponding to the fourth die DIE4 to which the 20^{th} block BLK20 belongs.

The control unit 1344 may decide whether one between a first condition and a second condition is satisfied or not, and decide to activate one between the mode 1 copy unit 1346 and the mode 2 copy unit 1348.

When an error block is detected, the control unit 1344 may decide whether the first condition is satisfied or not, and when the first condition is not satisfied, the control unit 1344 may decide whether the second condition is satisfied or not. Also, when no error block is detected, the control unit 1344 may not decide whether the first condition is satisfied or not but decide whether the second condition is satisfied or not. When the first condition is satisfied, the mode 1 copy unit 1346 may perform an operation, and when the second condition is satisfied, the mode 2 copy unit 1348 may perform an operation.

Herein, the first condition may represent a state that the victim list update unit 1342 stores the information on the error block in a victim list and the information on the error block is stored in all die fields of the oldest victim list. In short, the first condition may represent a case that the state of the oldest victim list is full of entries. The oldest victim list may be a victim list that is generated for the first time among the victim lists existing in the memory 144. Therefore, when no victim list is deleted by the victim list delete unit 1350, which will be described later, the first victim list V_LIST1 may become the oldest victim list. When the victim list delete unit 1350 deletes the first victim list V_LIST1, the second victim list V_LIST2 that is generated next to the first victim list V_LIST1 may become the oldest victim list.

When the first condition is satisfied, the control unit 1344 may decide to perform the operation of the mode 1 copy unit 1346 with respect to the oldest victim list.

Subsequently, when no error block is detected, or an error block is detected and thus the victim list update unit 1342 stores the information on the error block in a victim list but the first condition is not satisfied, the control unit 1344 may decide whether the second condition is satisfied or not.

Herein, the second condition may represent a state that the read count of the error block exceeds a predetermined second threshold value TH2 or a super block including the error block due to a write error is closed. The second threshold value TH2 may have a value that is greater than the first threshold value TH1, which is a reference for the decision of an error block, and equal to the read count threshold RTH, which is a reference for determining whether to perform a read reclaim operation. Furthermore, the closed super block may represent a super block in which all pages are programmed.

When the second condition is satisfied, the control unit 1344 may decide to perform the operation of the mode 2 copy unit 1348 with respect to the victim list including an error block that satisfies the second condition.

Referring to FIG. 5, when the physical block address PBA:BLK20 of the 20^{th} block BLK20 of the fourth die DIE4 is stored in the first victim list V_LIST1, the first victim list V_LIST1 may be full of entries. Therefore, the control unit 1344 may decide the first victim list V_LIST1 as satisfying the first condition. The control unit 1344 may decide to perform the operation of the mode 1 copy unit 1346 to the first victim list V_LIST1 which is the oldest victim list and satisfies the first condition.

When the first victim list V_LIST1 satisfies the first condition and the control unit 1344 decides to perform the operation of the mode 1 copy unit 1346 to the first victim list V_LIST1, the mode 1 copy unit 1346 may copy the data of the error blocks included in the oldest first victim list V_LIST1 into the destination super block DES_SBLK. Herein, the mode 1 copy unit 1346 may copy the data of the error blocks included in the oldest first victim list V_LIST1 into the blocks of the same dies as the error blocks of the first victim list V_LIST1, respectively, among a plurality of dies of the destination super block DES_SBLK.

According to the embodiment of the present invention, the destination super block DES_SBLK may include free blocks only.

Referring to FIG. 5, when the control unit 1344 decides to perform the mode 1 copy unit 1346, the mode 1 copy unit 1346 may refer to the physical block addresses PBA of the error blocks of the die fields DIE_F<1:4> of the first victim list V_LIST1, and copy the data of the error blocks into the blocks, in the destination super block DES_SBLK, of the same dies as the error blocks of the first victim list V_LIST1.

To be specific, since the physical block address PBA:BLK5 of the fifth block BLK5 of the first die DIE1 is stored as the entry of the first die field DIE_F1 of the first victim list V_LIST1, the mode 1 copy unit 1346 may copy data of the fifth block BLK5 included in the first die DIE1 of the second super block SBLK2 into a 25^{th} block BLK25 included in the first die DIE1 of the destination super block DES_SBLK.

Since the physical block address PBA: BLK2 of the second block BLK2 of the second die DIE2 is stored as the entry of the second die field DIE_F2 of the first victim list V_LIST1, the mode 1 copy unit 1346 may copy data of the second block BLK2 included in the second die DIE2 of the first super block SBLK1 into a 26^{th} block BLK26 included in the second die DIE2 of the destination super block DES_SBLK.

Since the physical block address PBA: BLK11 of the 11^{th} block BLK11 of the third die DIE3 is stored as the entry of the third die field DIE_F3 of the first victim list V_LIST1, the mode 1 copy unit 1346 may copy data of the 11^{th} block BLK11 included in the third die DIE3 of the third super block SBLK3 into a 27^{th} block BLK27 included in the third die DIE3 of the destination super block DES_SBLK.

Since the physical block address PBA: BLK20 of the 20^{th} block BLK20 of the fourth die DIE4 is stored as the entry of the fourth die field DIE_F4 of the first victim list V_LIST1, the mode 1 copy unit 1346 may copy data of the 20^{th} block BLK20 included in the fourth die DIE4 of the fifth super block SBLK5 into a 28^{th} block BLK28 included in the fourth die DIE4 of the destination super block DES_SBLK.

Consequently, when the copy operation of the mode 1 copy unit 1346 ends, data of the error blocks included in the first victim list V_LIST1, which is the oldest victim list, are copied into the destination super block DES_SBLK without changing their locations in terms of the die location. Therefore, the sequential attribute may be maintained continuously.

Meanwhile, when respective error blocks, the physical addresses of which are stored as the entries in the victim lists, satisfy the second condition and the control unit 1344 decides to perform the operation of the mode 2 copy unit 1348, the mode 2 copy unit 1348 may logically form a super block with the error block of the victim lists whose read count exceeds the second threshold value TH2 or an error block included in the closed super block among the error blocks of the victim lists and a victim block selected in a user data area of the memory device 150.

The mode 2 copy unit 1348 may copy the data of the error block and the victim block logically forming the super block into blocks in the destination super block DES_SBLK.

Herein, the mode 2 copy unit 1348 may copy the data of the error block into a block that is included in the same die as the error block among the dies that form the destination super block DES_SBLK, and copy the data of the victim block of the user data area into remaining block in the destination super block DES_SBLK.

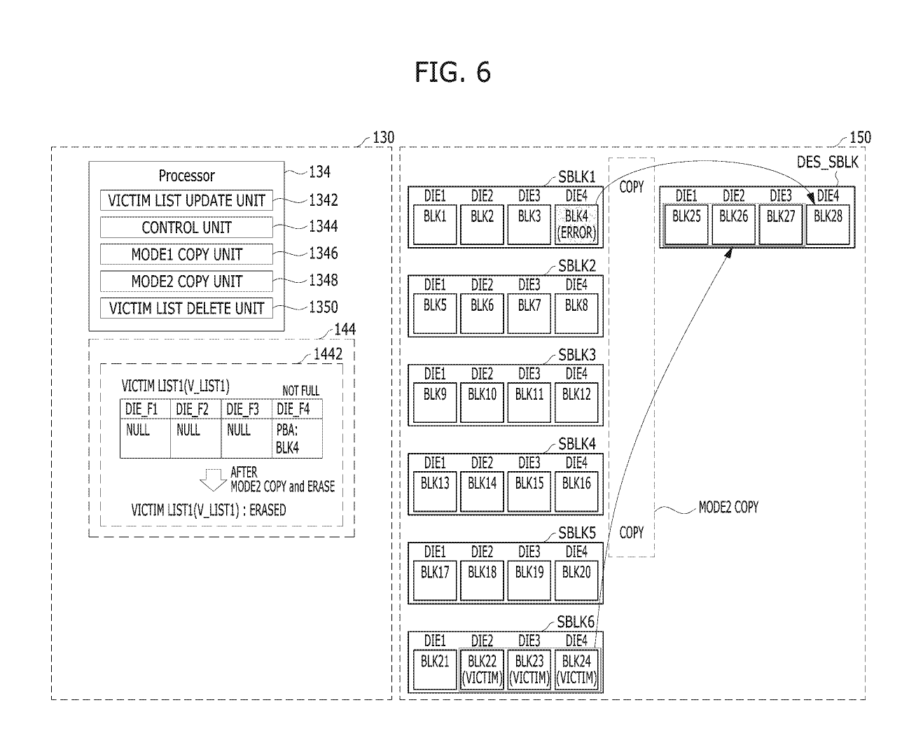

The specific operation of the mode 2 copy unit 1348 will be described later with reference to FIG. 6.

When the copy operation of the mode 1 copy unit 1346 or the mode 2 copy unit 1348 ends, the victim list delete unit 1350 may delete the victim list storing the information on the error block data of which is copied into the destination super block DES_SBLK from the storage unit 1442.

When the deleted victim list is the oldest victim list, the victim list that is generated next to the deleted oldest victim list may become the oldest victim list. For example, when the victim list delete unit 1350 deletes the first victim list V_LIST1, the second victim list V_LIST2 may become the oldest victim list.

FIG. 6 illustrates an operation of the mode 2 copy unit 1348 shown in FIG. 5. FIG. 6 exemplarily shows an error block of which the read count of the fourth block BLK4 of the fourth die DIE4 included in the first super block SBLK1 exceeds the second threshold value TH2. As described earlier, the second threshold value TH2 may be greater than the first threshold value TH1, which is a reference for deciding whether a block is an error block.

Also, FIG. 6 shows a case where there is no victim list in the storage unit 1442 of the memory 1444 and thus the victim list update unit 1342 generates a first victim list V_LIST1 including four die fields DIE_F<1:4>.

Referring to FIG. 6, the victim list update unit 1342 may store in the first victim list V_LIST1 the physical block address PBA: BLK4 of the fourth block BLK4 as the entry of the fourth die field DIE_F4 corresponding to the fourth die DIE4 to which the fourth block BLK4 belongs. Since there is no other error block, the state of the first victim list V_LIST1 becomes ‘not full’ because only the physical block address PBA: BLK4 of the fourth block BLK4 is stored in the fourth die field DIE_F4. Therefore, the first victim list V_LIST1 does not satisfy the first condition but satisfy the second condition.

As a result, the control unit 1344 may decide to perform the operation of the mode 2 copy unit 1348 with respect to the first victim list V_LIST1.

The victim list storing the information on the fourth block BLK4, which is an error block satisfying the second condition may be the first victim list V_LIST1, and there is no other error block except the fourth block BLK4 in the first victim list V_LIST1. In short, the number of the error block may be ‘1’. Therefore, the mode 2 copy unit 1348 may select the other three victim blocks among first to sixth super blocks SBLK<1:6>, which is the user data area, to logically form one super block that is formed of a total of four blocks.

For example, the mode 2 copy unit 1348 may select one super block that randomly stores data while including most invalid pages. Subsequently, the mode 2 copy unit 1348 may select as victim blocks three blocks that include most invalid pages among blocks included in the selected super block.

To be specific, referring to FIG. 6, the mode 2 copy unit 1348 may select as victim blocks a 22^{nd} block BLK22 included in the second die DIE2, a 23^{rd} block BLK23 included in the third die DIE3, and a 24^{th} block BLK24 included in the fourth die DIE4 in the sixth super block SBLK6. Therefore, the mode 2 copy unit 1348 may logically form one super block, which becomes a target for a copy operation of the mode 2 copy unit 1348, of a total of one error block included in the first victim list V_LIST1 and a total of three victim blocks selected from the sixth super block SBLK6.

Subsequently, the mode 2 copy unit 1348 may refer to the physical block address PBA: BLK4 of the fourth block BLK4 stored as the entry of the fourth die field DIE_F4 of the first victim list V_LIST1 and copy data of the fourth block BLK4 included in the first super block SBLK1 into the 28^{th} block BLK28 included in the fourth die DIE4 of the destination super block DES_SBLK.

The mode 2 copy unit 1348 may copy data of all the selected victim blocks, which are the 22^{nd} to 24^{th} blocks BLK<22:24>, into the 25^{th} to 27^{th} blocks BLK<25:27> of the destination super block DES_SBLK. Herein, since data are randomly stored in the victim blocks, read performance may not be deteriorated even though the data are copied into the destination super block DES_SBLK without consideration of the location of the dies.

Consequently, data of the valid pages of the 22^{nd} to 24^{th} blocks BLK<22:24>, which are the victim blocks, may be stored in the first to third dies DIE<1:3> of the destination super block DES_SBLK, and data of the valid pages of the fourth block BLK4, which is an error block, may be stored in the fourth die DIE4 of the destination super block DES_SBLK.

When the copy operation of the mode 2 copy unit 1348 ends, the victim list delete unit 1350 may delete the first victim list V_LIST1, which is the only victim list stored in the storage unit 1442. Therefore, there is no oldest victim list.

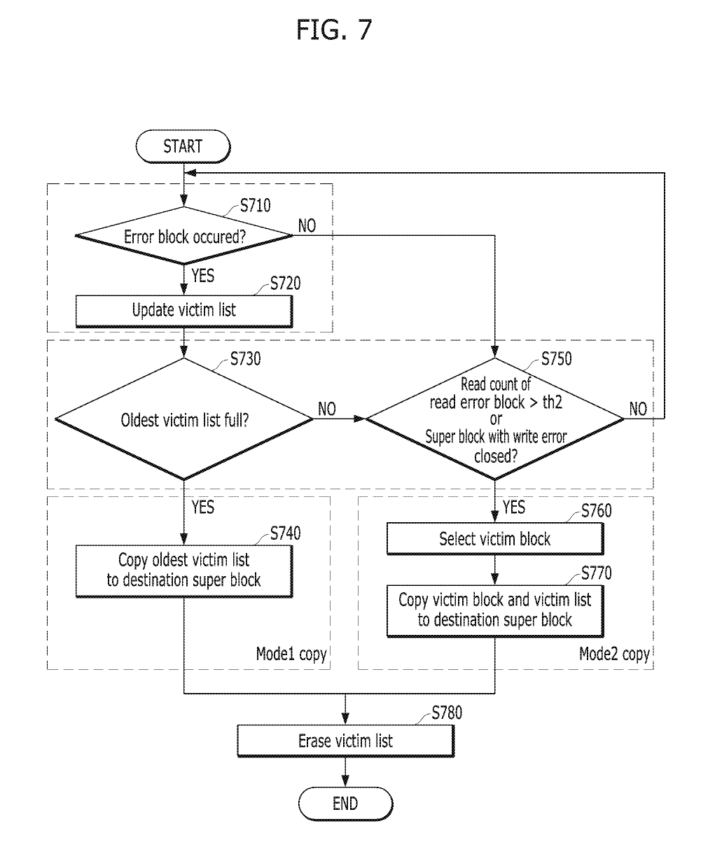

FIG. 7 is a flowchart describing an error management operation in accordance with an embodiment of the present invention.

Hereafter, the error management operation in accordance with the embodiment of the present invention will be described with reference to FIGS. 5 to 7.

When, in step S710, an error block is detected in a die of a super block (YES), then in step S720, the victim list update unit 1342 may store in a victim list information on the error block, e.g., a physical block address PBA of the error block as an entry of a die field representing the error-detected die. Herein, the error block may represent a block that is likely to have a read error or a block where a write error is detected. The victim list may be made in units of super blocks, and may be already made before the current detection of the error block or may be currently made at the time point of the current detection of the error block, as described above. When the storage unit 1442 stores a plurality of victim lists, the victim list update unit 1342 may store a physical block address PBA of the currently detected error block as an entry in the oldest victim list.

When no error block is detected in the step S710 (NO), the control unit 1344 may decide whether or not the second condition is satisfied and decide whether or not to operate the mode 2 copy unit 1348 in step S750. This will be described in detail in the following step S750.

In step S730, the control unit 1344 may decide whether the first condition is satisfied or not, that is, whether the state of the oldest victim list is full or not, and decide whether to operate the mode 1 copy unit 1346 or not.

In the step S730, when the state of the oldest victim list is full (YES), that is, when the information on the error blocks are stored as the entries of all die fields of the oldest victim list, the control unit 1344 may decide to perform the operation of the mode 1 copy unit 1346 with respect to the oldest victim list.

Conversely, in the step S730, when the state of the oldest victim list is not full (NO), the control unit 1344 may decide whether the second condition is satisfied or not and thereby decide whether to perform the operation of the mode 2 copy unit 1348 in the step S750. This will be described in detail in the following step S750.

When the first condition is satisfied and the control unit 1344 decides to perform the operation of the mode 1 copy unit 1346 in the step S730 (YES), the mode 1 copy unit 1346 may copy the data of the error blocks included in the oldest victim list into the destination super block DES_SBLK in step S740. Herein, the mode 1 copy unit 1346 may copy the data of the error blocks into the blocks of the same dies as the error blocks, respectively, among a plurality of dies that form the destination super block DES_SBLK.

When no error block is detected in the step S710 (NO), the control unit 1344 may decide whether the second condition is satisfied or not and decide whether to perform the operation of the mode 2 copy unit 1348 in the step S750.

Also, when the state of the oldest victim list is not full in the step S730 (NO) although the error block is detected in the step S710 (YES), the control unit 1344 may decide whether the second condition is satisfied or not and decide whether to perform the operation of the mode 2 copy unit 1348 in the step S750.

When the second condition is satisfied in the step S750 (YES), the mode 2 copy unit 1348 may select victim blocks to perform a copy operation in step S760.

Conversely, when the second condition is not satisfied in the step S750 (NO), the process may go back to the step S710 and the victim list update unit 1342 may continuously decide whether an error block is detected or not.

When the second condition is satisfied and the control unit 1344 decides to perform the operation of the mode 2 copy unit 1348 in the step S750 (YES), the mode 2 copy unit 1348 may logically form a super block of an error block whose read count exceeds the second threshold value TH2 or an error block included in a super block of a closed state as an error block registered in a victim list and of a victim block selected in a user area of the memory device 150 in the step S760.

In the step S760, when the mode 2 copy unit 1348 selects a victim block and logically forms a super block S_BLK, which is a target for a copy operation of the mode 2 copy unit 1348, the mode 2 copy unit 1348 may copy the data of the error block and the victim block that logically form the super block into the location of an arbitrary die of the destination super block DES_SBLK in step S770.

In short, the mode 2 copy unit 1348 may copy the data of the error block included in the logically formed super block into a block included in a die to which the error block belongs among a plurality of dies that form the destination super block DES_SBLK, and copy the data of the victim block of a user area that is included in the logically formed super block into the other blocks among the dies that form the destination super block DES_SBLK.

When the copy operation by the mode 1 copy unit 1346 in the step S740 or the copy operation by the mode 2 copy unit 1348 in the step S770 are performed, the victim list delete unit 1350 may delete the victim list storing the information on the error block that is copied into the destination super block DES_SBLK from the storage unit 1442 in step S780.

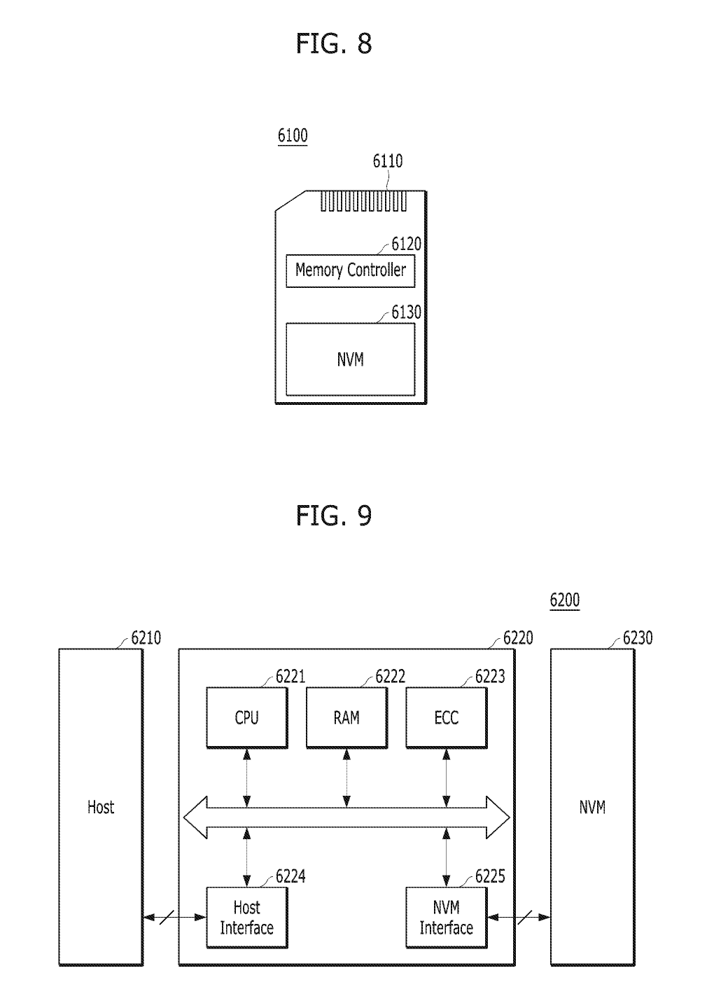

Hereafter, a data processing system and electronic devices to which the memory system 110 including the memory device 150 and the controller 130 that are described with reference to FIGS. 1 to 8 in accordance with the embodiments of the present invention are described in detail with reference to FIGS. 8 to 16.

FIG. 8 is a diagram schematically illustrating another example of the data processing system including the memory system in accordance with the present embodiment. FIG. 8 schematically illustrates a memory card system to which the memory system in accordance with the present embodiment is applied.

Referring to FIG. 8, the memory card system 6100 may include a memory controller 6120, a memory device 6130 and a connector 6110.

More specifically, the memory controller 6120 may be connected to the memory device 6130 embodied by a nonvolatile memory, and configured to access the memory device 6130. For example, the memory controller 6120 may be configured to control read, write, erase and background operations of the memory device 6130. The memory controller 6120 may be configured to provide an interface between the memory device 6130 and a host, and drive firmware for controlling the memory device 6130. That is, the memory controller 6120 may correspond to the controller 130 of the memory system 110 described with reference to FIG. 1, and the memory device 6130 may correspond to the memory device 150 of the memory system 110 described with reference to FIG. 1.

Thus, the memory controller 6120 may include a RAM, a processing unit, a host interface, a memory interface and an error correction unit.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system in accordance with the present embodiment may be applied to wired/wireless electronic devices or particularly mobile electronic devices.

The memory device 6130 may be implemented by a nonvolatile memory. For example, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM).

The memory controller 6120 and the memory device 6130 may be integrated into a single semiconductor device. For example, the memory controller 6120 and the memory device 6130 may construct a solid-state driver (SSD) by being integrated into a single semiconductor device. Also, the memory controller 6120 and the memory device 6130 may construct a memory card such as a PC card (PCMCIA: Personal Computer Memory Card International Association), a compact flash (CF) card, a smart media card (e.g., SM and SMC), a memory stick, a multimedia card (e.g., MMC, RS-MMC, MMCmicro and eMMC), an SD card (e.g., SD, miniSD, microSD and SDHC) and a universal flash storage (UFS).

FIG. 9 is a diagram schematically illustrating another example of the data processing system including the memory system in accordance with the present embodiment.

Referring to FIG. 9, the data processing system 6200 may include a memory device 6230 having one or more nonvolatile memories and a memory controller 6220 for controlling the memory device 6230. The data processing system 6200 illustrated in FIG. 9 may serve as a storage medium such as a memory card (CF, SD, micro-SD or the like) or USB device, as described with reference to FIG. 1. The memory device 6230 may correspond to the memory device 150 in the memory system 110 illustrated in FIG. 1, and the memory controller 6220 may correspond to the controller 130 in the memory system 110 illustrated in FIG. 1.

The memory controller 6220 may control a read, write or erase operation on the memory device 6230 in response to a request of the host 6210, and the memory controller 6220 may include one or more CPUs 6221, a buffer memory such as RAM 6222, an ECC circuit 6223, a host interface 6224 and a memory interface such as an NVM interface 6225.

The CPU 6221 may control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the low-speed memory device 6230 to operate at high speed.

The ECC circuit 6223 may correspond to the ECC unit 138 of the controller 130 illustrated in FIG. 1. As described with reference to FIG. 1, the ECC circuit 6223 may generate an ECC (Error Correction Code) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. At this time, the ECC circuit 6223 may correct an error using the parity bit. For example, as described with reference to FIG. 1, the ECC circuit 6223 may correct an error using the LDPC code, BCH code, turbo code, Reed-Solomon code, convolution code, RSC or coded modulation such as TCM or BCM.

The memory controller 6220 may transmit/receive data to/from the host 6210 through the host interface 6224, and transmit/receive data to/from the memory device 6230 through the NVM interface 6225. The host interface 6224 may be connected to the host 6210 through a PATA bus, SATA bus, SCSI, USB, PCIe or NAND interface. The memory controller 6220 may have a wireless communication function with a mobile communication protocol such as WiFi or Long Term Evolution (LTE). The memory controller 6220 may be connected to an external device, for example, the host 6210 or another external device, and then transmit/receive data to/from the external device. In particular, as the memory controller 6220 is configured to communicate with the external device through one or more of various communication protocols, the memory system and the data processing system in accordance with the present embodiment may be applied to wired/wireless electronic devices or particularly a mobile electronic device.

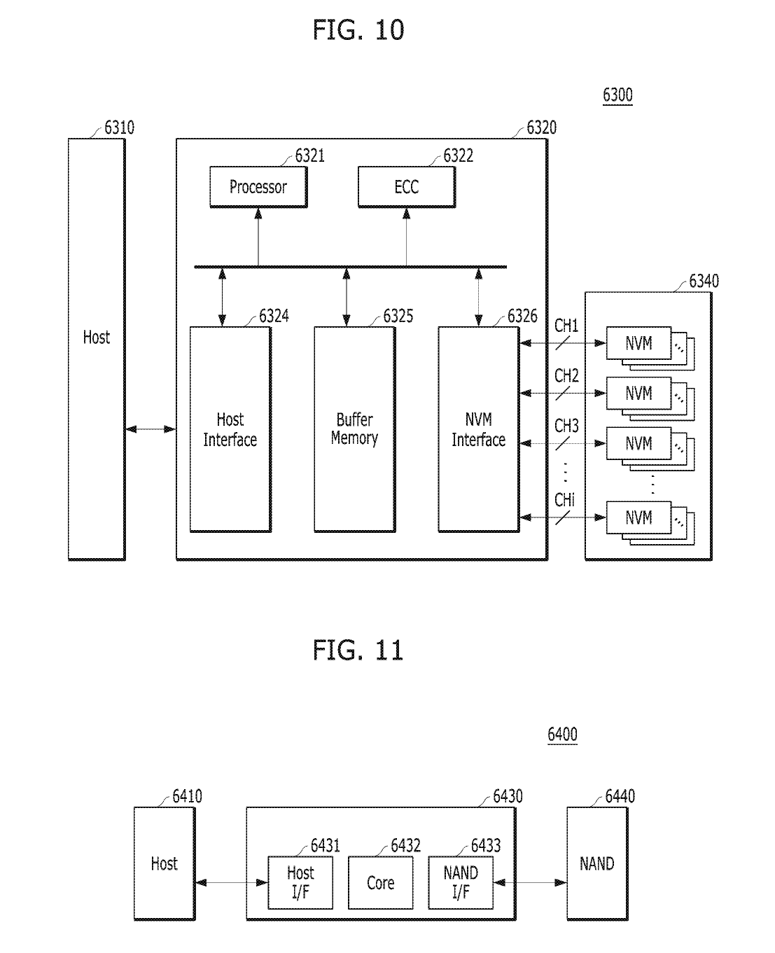

FIG. 10 is a diagram schematically illustrating another example of the data processing system including the memory system in accordance with the present embodiment. FIG. 11 schematically illustrates an SSD to which the memory system in accordance with the present embodiment is applied.

Referring to FIG. 10, the SSD 6300 may include a controller 6320 and a memory device 6340 including a plurality of nonvolatile memories. The controller 6320 may correspond to the controller 130 in the memory system 110 of FIG. 1, and the memory device 6340 may correspond to the memory device 150 in the memory system of FIG. 1

More specifically, the controller 6320 may be connected to the memory device 6340 through a plurality of channels CH1 to CHi. The controller 6320 may include one or more processors 6321, a buffer memory 6325, an ECC circuit 6322, a host interface 6324 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by volatile memories such as DRAM, SDRAM, DDR SDRAM, LPDDR SDRAM and GRAM or nonvolatile memories such as FRAM, ReRAM, STT-MRAM and PRAM. For convenience of description, FIG. 8 illustrates that the buffer memory 6325 exists in the controller 6320. However, the buffer memory 6325 may exist outside the controller 6320.

The ECC circuit 6322 may calculate an ECC value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, for example, RAID (Redundant Array of Independent Disks) system. At this time, the RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 11 is a diagram schematically illustrating another example of the data processing system including the memory system in accordance with the present embodiment. FIG. 11 schematically illustrates an embedded Multi-Media Card (eMMC) to which the memory system in accordance with the present embodiment is applied.

Referring to FIG. 11, the eMMC 6400 may include a controller 6430 and a memory device 6440 embodied by one or more NAND flash memories. The controller 6430 may correspond to the controller 130 in the memory system 110 of FIG. 1, and the memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control overall operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, UHS ((Ultra High Speed)-I/UHS-II) interface.

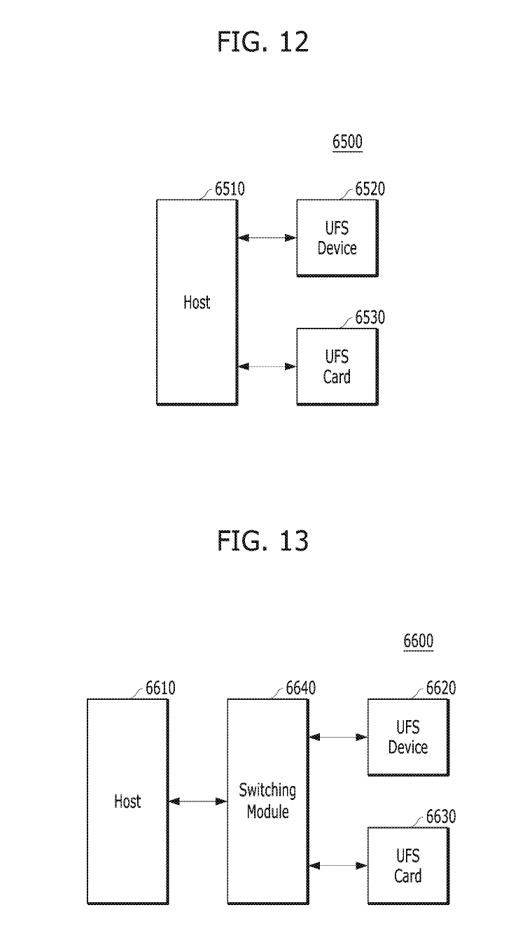

FIGS. 12 to 15 are diagrams schematically illustrating other examples of the data processing system including the memory system in accordance with the present embodiment. FIGS. 12 to 15 schematically illustrate UFS (Universal Flash Storage) systems to which the memory system in accordance with the present embodiment is applied.

Referring to FIGS. 12 to 15, the UFS systems 6500, 6600, 6700 and 6800 may include hosts 6510, 6610, 6710 and 6810, UFS devices 6520, 6620, 6720 and 6820 and UFS cards 6530, 6630, 6730 and 6830, respectively. The hosts 6510, 6610, 6710 and 6810 may serve as application processors of wired/wireless electronic devices or particularly mobile electronic devices, the UFS devices 6520, 6620, 6720 and 6820 may serve as embedded UFS devices, and the UFS cards 6530, 6630, 6730 and 6830 may serve as external embedded UFS devices or removable UFS cards.

The hosts 6510, 6610, 6710 and 6810, the UFS devices 6520, 6620, 6720 and 6820 and the UFS cards 6530, 6630, 6730 and 6830 in the respective UFS systems 6500, 6600, 6700 and 6800 may communicate with external devices, for example, wired/wireless electronic devices or particularly mobile electronic devices through UFS protocols, and the UFS devices 6520, 6620, 6720 and 6820 and the UFS cards 6530, 6630, 6730 and 6830 may be embodied by the memory system 110 illustrated in FIG. 1. For example, in the UFS systems 6500, 6600, 6700 and 6800, the UFS devices 6520, 6620, 6720 and 6820 may be embodied in the form of the data processing system 6200, the SSD 6300 or the eMMC 6400 described with reference to FIGS. 10 to 12, and the UFS cards 6530, 6630, 6730 and 6830 may be embodied in the form of the memory card system 6100 described with reference to FIG. 8.

Furthermore, in the UFS systems 6500, 6600, 6700 and 6800, the hosts 6510, 6610, 6710 and 6810, the UFS devices 6520, 6620, 6720 and 6820 and the UFS cards 6530, 6630, 6730 and 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720 and 6820 and the UFS cards 6530, 6630, 6730 and 6830 may communicate with each other through various protocols other than the UFS protocol, for example, UFDs, MMC, SD, mini-SD, and micro-SD.

In the UFS system 6500 illustrated in FIG. 12, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. At this time, the UFS device 6520 and the UFS card 6530 may communicate with each other through link layer switching at the UniPro of the host 6510. In the present embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6410, and a plurality of UFS cards may be connected in parallel or in the form of a star to the UFS device 6520 or connected in series or in the form of a chain to the UFS device 6520.

In the UFS system 6600 illustrated in FIG. 13, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the present embodiment, the configuration in which one UFS device 6620 and one UFS card 6630 are connected to the switching module 6640 has been exemplified for convenience of description. However, a plurality of UFS devices and UFS cards may be connected in parallel or in the form of a star to the switching module 6640, and a plurality of UFS cards may be connected in series or in the form of a chain to the UFS device 6620.

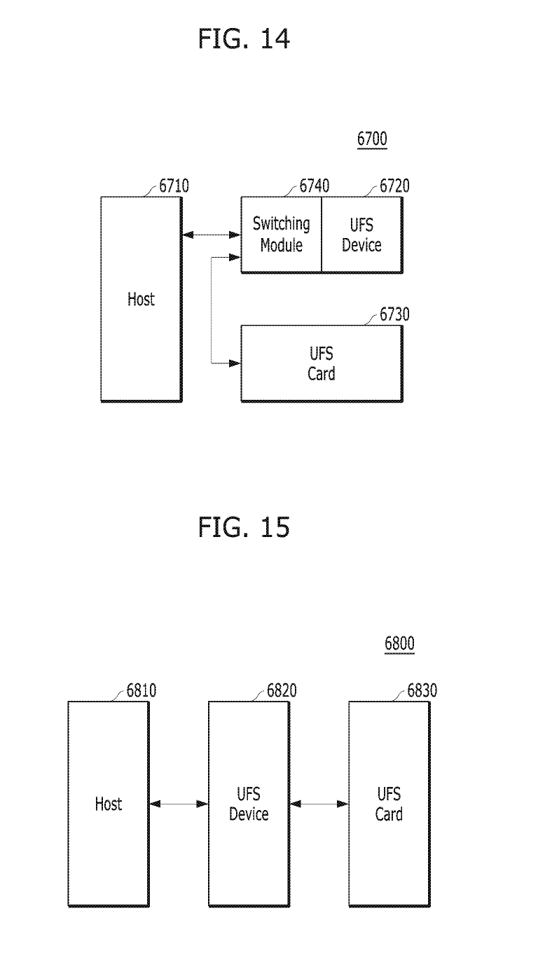

In the UFS system 6700 illustrated in FIG. 14, each of the host 6710, the UFS device 6720 and the UFS card 6730 may include UniPro, and the host 6710 may communicate with the UFS device 6720 or the UFS card 6730 through a switching module 6740 performing a switching operation, for example, through the switching module 6740 which performs link layer switching at the UniPro, for example, L3 switching. At this time, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. In the present embodiment, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 15, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target ID (Identifier) switching operation. At this time, the host 6810 and the UFS card 6830 may communicate with each other through target ID switching between the M-PHY and UniPro modules of the UFS device 6820. In the present embodiment, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

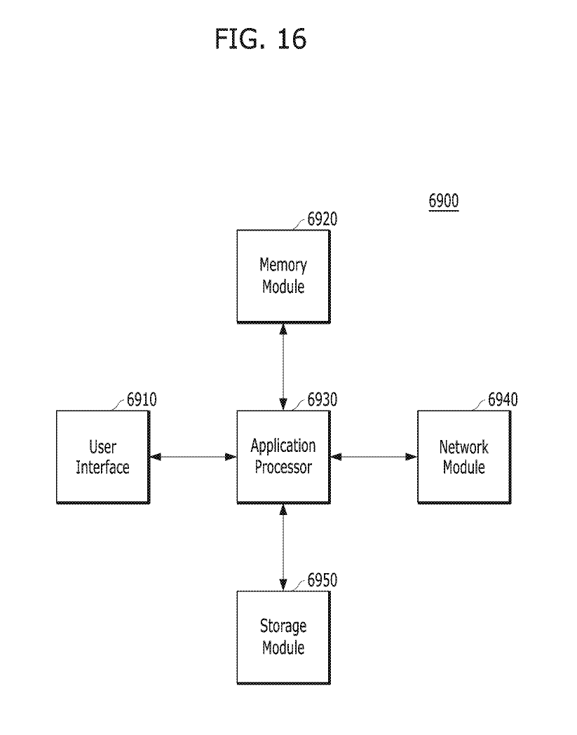

FIG. 16 is a diagram schematically illustrating another example of the data processing system including the memory system in accordance with an embodiment. FIG. 16 is a diagram schematically illustrating a user system to which the memory system in accordance with the present embodiment is applied.

Referring to FIG. 16, the user system 6900 may include an application processor 6930, a memory module 6920, a network module 6940, a storage module 6950 and a user interface 6910.

More specifically, the application processor 6930 may drive components included in the user system 6900, for example, an OS, and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile RAM such as DRAM, SDRAM, DDR SDRAM, DDR2 SDRAM, DDR3 SDRAM, LPDDR SDARM, LPDDR3 SDRAM or LPDDR3 SDRAM or a nonvolatile RAM such as PRAM, ReRAM, MRAM or FRAM. For example, the application processor 6930 and the memory module 6920 may be packaged and mounted, based on POP (Package on Package).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, eMMC and UFS as described above with reference to FIGS. 10 to 15.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a monitor.

Furthermore, when the memory system 110 of FIG. 1 is applied to a mobile electronic device of the user system 6900, the application processor 6930 may control overall operations of the mobile electronic device, and the network module 6940 may serve as a communication module for controlling wired/wireless communication with an external device. The user interface 6910 may display data processed by the processor 6930 on a display/touch module of the mobile electronic device, or support a function of receiving data from the touch panel.

According to the embodiments of the present invention, deterioration of read performance may be prevented by managing and copying an error block for each die and maintaining sequential attributes.

While the present invention has been described with respect to the specific embodiments, it will be apparent to those skilled in the art that various changes and modifications may be made without departing from the spirit and scope of the invention as defined in the following claims.

What is claimed is:

1. A controller, comprising:
a victim list update unit suitable for storing information on an error block in a victim list when the error block is detected;
a control unit suitable for deciding whether or not to perform a copy operation based on whether or not a predetermined condition is satisfied;
a copy unit suitable for copying the error block into a destination super block while maintaining a location of a die when the control unit performs the copy operation; and
a victim list delete unit suitable for deleting the victim list including the error block when the copy operation ends.

2. The controller of claim 1, wherein the predetermined condition is a condition where a state of an oldest victim list is full.

3. The controller of claim 1, wherein the error block is a block that is to have a read error or a block where a write error is detected, and wherein the predetermined condition is one between a condition that a read count of the error block exceeds a predetermined second threshold value and a condition that a state of a super block including the error block is ‘closed’.

4. The controller of claim 1, wherein the victim list update unit stores the information on the error block in the victim list for each die.

5. The controller of claim 1, wherein the information on the error block is a physical block address of the detected error block.

6. The controller of claim 1, wherein the victim list is stored in a volatile memory.

7. The controller of claim 1, wherein the block that is likely to have a read error is a block where a read count of the block exceeds a predetermined first threshold value.

8. The controller of claim 2, wherein when the predetermined condition is satisfied,
the copy unit copies the error block that belongs to a victim list satisfying the predetermined condition into the destination super block while maintaining the location of the die.

9. The controller of claim 3, wherein when the predetermined condition is satisfied,
the copy unit copies the error block that belongs to a victim list including the error block satisfying the predetermined condition into the destination super block while maintaining the location of the die, and copies a victim block selected from a user area into the destination super block.

10. The controller of claim 9, wherein a block including invalid pages most is selected as the victim block.

11. A method for operating a controller, comprising:
when an error block is detected, storing information on the error block in a victim list;
deciding whether to perform a copy operation or not based on whether a predetermined condition is satisfied or not;
when the copy operation is decided to be performed, copying the error block, which is a target for the copy operation, into a destination super block while maintaining a location of a die; and
when the copy operation ends, deleting the victim list including the error block, which is the target for the copy operation.

12. The method of claim 11, wherein the predetermined condition is a condition where a state of an oldest victim list is full.

13. The method of claim 11, wherein the error block is a block that is to have a read error or a block where a write error is detected and wherein the predetermined condition is one between a condition that a read count of the error block exceeds a predetermined second threshold value and a condition that a state of a super block including the error block is closed.

14. The method of claim 11, wherein in the storing of the information on the error block in the victim list,
the information on the error block is stored in the victim list for each die.

15. The method of claim 11, wherein the information on the error block is a physical block address of the detected error block.

16. The method of claim 11, wherein the victim list is stored in a volatile memory.

17. The method of claim 11, wherein the block that is likely to have the read error is a block where a read count of the block exceeds a predetermined first threshold value.

18. The method of claim 12, wherein when the predetermined condition is satisfied,
the error block that belongs to a victim list satisfying the predetermined condition is copied into the destination super block while maintaining the location of the die in the copying of the error block, which is the target for the copy operation, into the destination super block while maintaining the location of the die.

19. The method of claim 13, wherein when the predetermined condition is satisfied,
the error block that belongs to a victim list including the error block satisfying the predetermined condition is copied into the destination super block while maintaining the location of the die, and a victim block selected from a user area is copied into the destination super block in the copying of the error block, which is the target for the copy operation, into the destination super block while maintaining the location of the die.

20. The method of claim 19, wherein a block including invalid pages most is selected as the victim block.
